(19) United States
(12) Patent Application Publication
(10) Pub. No.: US 2026/0244576 A1
(43) Pub. Date: Aug. 20, 2026

(54) HARDWARE-ASSISTED PAGE TABLE MANAGEMENT SYSTEM AND METHOD, MEDIUM, PROGRAM PRODUCT, AND TERMINAL

(71) Applicant: Shanghai Jiao Tong University, Shanghai (CN)

(72) Inventors: Li JIANG, Shanghai (CN); Fangxin LIU, Shanghai (CN); Longyu ZHAO, Shanghai (CN); Zongwu WANG, Shanghai (CN)

(73) Assignee: Shanghai Jiao Tong University, Shanghai (CN)

(21) Appl. No.: 19/417,254

(22) Filed: Dec. 11, 2025

(30) Foreign Application Priority Data
Dec. 13, 2024 (CN) 202411840655.X

(51) Int. Cl. G06F 12/1009; G06F 12/0897; G06F 12/1045

(52) U.S. Cl. CPC G06F 12/1009; G06F 12/0897; G06F 12/1045; G06F 2212/1021

(57) ABSTRACT

This application provides a hardware-assisted page table management system and method, a medium, a program product, and a terminal, to achieve efficient address translation through collaborative operation of a memory management unit and a memory cell. The method includes key steps such as translation lookaside buffer hit detection, guest page table lookup, and page walk cache lookup. After receiving an access instruction, the memory management unit performs detection through a translation lookaside buffer hit detection module. If a miss occurs, a guest page table lookup module acquires a corresponding host physical address. The system performs lookup in a page walk cache module, accesses a second-level cache of the memory cell when necessary, and stores a lookup result into a cache line of a preset format. This application achieves transparent translation of guest page table addresses in a cache through hardware-assisted means, providing a comprehensive lifecycle management solution for shadow page table entries.

### CROSS REFERENCE TO RELATED APPLICATION

This patent application claims the benefit and priority of Chinese Patent Application No. 202411840655X, filed with the China National Intellectual Property Administration on Dec. 13, 2024, the disclosure of which is incorporated by reference herein in its entirety as part of the present application.

### TECHNICAL FIELD

This application relates to the field of computer processor architectures, and in particular, to a hardware-assisted page table management system and method, a medium, a program product, and a terminal.

### BACKGROUND

In modern virtualized environments, virtual machines (VM) provide users with secure sandboxed environments by multiplexing across a plurality of hardware resources. As the cornerstone of cloud computing, the virtualization technology decouples hardware from software, and allows a plurality of operating systems and applications to be simultaneously run on a single machine. This separation significantly improves resource utilization, reduces costs, enhances system security, and achieves large-scale services. However, virtualization introduces substantial address translation overheads, primarily due to the sequential access of multi-level radix page tables. In modern x86-64 architectures, four-level page tables divide 48-bit virtual addresses into four segments, which are then translated into physical addresses through sequential memory access. While this method reduces the storage space required for page tables, in non-virtualized environments, a single translation lookaside buffer miss may require up to four sequential memory accesses. In virtualized environments, page tables are organized in a multi-level tree structure. The virtual address of the guest operating system (guest virtual address, gVA) needs to be translated into a guest physical address (gPA) through the guest page table (gPT). The gPA then serves as the virtual address of the host operating system (host virtual address, hVA), and is then translated through the nested page table (nPT) into a host physical address (hPA) to access the final data.

To address these issues, the industry has widely adopted hardware-assisted virtualization technologies, such as Intel's extended page table (EPT) and AMD's nPT. These technologies leverage hardware capabilities to cache address translations, thereby reducing the complexity of nPT lookups. Additionally, shadow page tables are maintained by the virtual machine monitor (VMM) or hypervisor, providing each VM with a direct mapping from virtual addresses to physical addresses. Although shadow page tables reduce the need for page table lookups, each time the guest operating system updates the page tables, a virtual machine exit is required, resulting in significant performance overheads. Victima is an emerging technology that enhances translation efficiency by utilizing underutilized L2 cache resources. Victima leverages L2 cache lines to store evicted TLB entries, providing an additional low-latency, high-capacity backup component, to support the last-level TLB and reduce page table walker (PTW) overheads.

Although the existing technical solutions partially resolve the address translation issues in virtualized environments, each has limitations. While the TLB and shadow page table technologies reduce the address translation time, the efficiency is constrained under high loads or large memory workloads. Shadow page tables, in particular, impose a non-trivial performance burden due to frequent VM exits. Although the Victima leverages the L2 caches to enhance the TLB caching capability, the high cache utilization and potential performance saturation limit the practical application advantages of the Victima. Moreover, although hardware-assisted address translation reduces the software overheads, TLB misses and the high latency of page table walks remain significant challenges under the growing demand for memories. The limitations of these technologies indicate that optimizing address translation in virtualized environments still requires more innovative solutions to further improve efficiency and performance.

### SUMMARY

In view of the shortcomings of the prior art described above, this application is intended to provide a hardware-assisted page table management system and method, a medium, a program product, and a terminal, to resolve impact on system performance and responsiveness as a result of limitations in efficiency of address translation under high-load and large-memory workloads in existing page table management technologies.

To achieve the foregoing objective and other related objectives, a first aspect of this application provides a hardware-assisted page table management system, including a memory management unit (MMU) and a memory cell. The MMU includes a translation lookaside buffer (TLB) hit detection module, a guest page table lookup module, and a page walk cache module. The memory cell includes a first-level cache and a second-level cache. An interaction mode of the hardware-assisted page table management system includes following steps: receiving, by the MMU, an access instruction, performing, by the TLB hit detection module, a hit detection operation according to the access instruction, and acquiring, by the guest page table lookup module according to the access instruction, a host physical address corresponding to the access instruction if a TLB miss occurs; performing, by the MMU, a page table lookup operation in the page walk cache module based on the host physical address, and sending, by the MMU, the host physical address to the memory cell to initiate an address translation request in response to a failed lookup; performing, by the memory cell, a page table lookup operation in the second-level cache based on the host physical address, and storing a found guest page table entry into a cache line of a preset format and storing the cache line of the preset format into the second-level cache and the page walk cache module in response to a successful lookup; and sending, by the page walk cache module, a shadow page table entry to the guest page table lookup module, for the guest page table lookup module to perform a corresponding access operation based on the shadow page table entry.

In some embodiments of the first aspect of this application, the cache line of the preset format includes a flag, a status bit, a plurality of gPT entries, and a first shadow flag bit. Each gPT entry includes a second shadow flag bit and a page number. The first shadow flag bit includes a first flag and a second flag, the first flag is used to indicate that a current cache line includes a gPT entry replaced with the shadow page table entry, and the second flag is used to indicate that a current cache line does not include a gPT entry replaced with the shadow page table entry. The second shadow flag bit includes a third flag and a fourth flag, the third flag is used to indicate that a current gPT entry is replaced with the shadow page table entry, and the fourth flag is used to indicate that a current gPT entry is not replaced with the shadow page table entry.

In some embodiments of the first aspect of this application, a process in which the gPT entry found through lookup is stored into the cache line of the preset format into the second-level cache includes: performing, by the second-level cache, determination on the second shadow flag bit in the current gPT entry, translating the current gPT entry into a corresponding shadow page table entry through a nested page table addresser in the memory cell and setting the second shadow flag bit to a third flag if the second shadow flag bit is a fourth flag, storing the translated gPT entry into the current cache line, and setting the first shadow flag bit of the current cache line to the first flag.

In some embodiments of the first aspect of this application, the interaction mode of the system includes one or more of following steps: sending, if a first-level cache miss occurs concurrently with a second-level cache hit and a second shadow flag bit of a guest page table entry that hits a request is a fourth flag, the guest page table entry that hits the request to the first-level cache of the memory cell; requesting another layer of cache structure or a dynamic random access memory (DRAM) to provide a cache line without shadow page table entries if a first-level cache miss occurs concurrently with a second-level cache hit and the second shadow flag bit of the guest page table entry that hits the request is a third flag, where the cache line without shadow page table entries is sent to the first-level cache of the memory cell; and performing, by the MMU and the memory cell, a guest page table entry coherency maintenance operation if a first-level cache miss occurs concurrently with a second-level cache miss.

In some embodiments of the first aspect of this application, the guest page table lookup module includes a guest page table walker (GPTW) and a first register, and the first register includes a valid bit and a host physical address bit, where an initial state of the valid bit is an invalid state.

In some embodiments of the first aspect of this application, a process in which the guest page table lookup module acquires, according to the access instruction, the hPA corresponding to the access instruction includes: communicatively connecting the first register to the second register, and acquiring, by the first register a gPA from the second register according to the access instruction; searching, by the second register, a host page table walker for a corresponding hPA based on the gPA, and sending the hPA to the first register; and storing, by the MMU, the hPA into the first register, and setting the valid bit in the first register to a valid state.

To achieve the foregoing objective and other related objectives, a second aspect of this application provides a hardware-assisted page table management system. The method includes: receiving an access instruction, performing a hit detection operation according to the access instruction, acquiring, according to the access instruction, a host physical address corresponding to the access instruction if a TLB miss occurs, and performing a valid bit setting operation; performing a page table lookup operation based on the hPA, performing a page table lookup operation in a second-level cache based on the hPA in response to a failed lookup, and storing a gPT entry found through lookup into a cache line of a preset format and storing the cache line of the preset format into the second-level cache in response to a successful lookup; and performing a corresponding access operation based on a shadow page table entry.

To achieve the foregoing objective and other related objectives, a third aspect of this application provides a computer-readable storage medium, having a computer program stored therein. The computer program, when executed by a processor, the hardware-assisted page table management method.

To achieve the foregoing objective and other related objectives, a fourth aspect of this application provides a computer program product, including computer program code. The computer program code, when run on a computer, causes the computer to perform the hardware-assisted page table management method.

To achieve the foregoing objective and other related objectives, a fifth aspect of this application provides an electronic terminal, including a memory, a processor, and a computer program stored in the memory. The processor is configured to execute the computer program to implement the hardware-assisted page table management method.

As described above, the hardware-assisted page table management system and method, the medium, the program product, and the terminal of this application have the following beneficial effects: 1) Transparent translation of guest page table addresses in the cache is achieved through hardware assistance, effectively reducing address translation overheads. 2) An innovative lifecycle management scheme is designed for shadow page table entries, ensuring stability and reliability of system operation. 3) A unique guest operating system is used to maintain page tables, achieving transparency at software levels and reducing system complexity. Experimental results show that, compared to the existing technologies, performance improvement of the present disclosure is significant, achieving a 17% increase over nested paging and an 8.5% increase over Victima. This brings performance of virtualized environments to 89% of native performance, substantially enhancing overall performance of a virtualization system.

### BRIEF DESCRIPTION OF THE DRAWINGS

FIG. 1 is a schematic structural diagram of a hardware-assisted page table management system according to an embodiment of this application.

FIG. 2 is a schematic flowchart of an interaction process of the hardware-assisted page table management system according to an embodiment of this application.

FIGS. 3A-3B are schematic structural diagrams of an SgCR3 register and a gCR3 register of the hardware-assisted page table management system according to an embodiment of this application.

FIG. 4 is a schematic structural diagram of a cache line of the hardware-assisted page table management system according to an embodiment of this application.

FIG. 5 is a schematic flowchart of address translation of the hardware-assisted page table management system according to an embodiment of this application.

FIGS. 6A-6C are schematic flowchart of different hit scenarios of the hardware-assisted page table management system according to an embodiment of this application.

FIG. 7 is a schematic diagram of effects of the hardware-assisted page table management system under a plurality of load conditions according to an embodiment of this application.

FIG. 8 is a schematic flowchart of a hardware-assisted page table management method according to an embodiment of this application.

FIG. 9 is a schematic structural diagram of a hardware-assisted page table management terminal according to an embodiment of this application.

### DETAILED DESCRIPTION OF THE EMBODIMENTS

Implementations of this application are described below through specific examples, and a person skilled in the art can easily understand other advantages and effects of this application from contents disclosed in this specification. This application may alternatively be implemented or applied through other different specific implementations. Based on different viewpoints and applications, various modifications or changes may be made to various details of this specification without departing from the spirit of this application. It should be noted that following embodiments and features in the embodiments may be combined with each other provided that no conflict occurs.

Before a more detailed explanation of the present disclosure is provided, nouns and terms used in the embodiments of this application are described. The nouns and terms used in the embodiments of this application are explained as follows:
1. Page table management: It is a process of creating, updating, and maintaining page tables. Page tables are used for an operating system to manage mappings between virtual memories and physical memories.
2. Memory management unit (MMU): It is a computer hardware component responsible for translating virtual addresses into physical addresses and implementing memory protection and address space management.
3. Memory cell: It is a fundamental component of a computer memory, and is responsible for persistently storing data. Its internal structure includes a plurality of levels of caches, such as an L1 cache, a L2 cache, and a L3 cache. It also supports mappings of guest page table entries (gPT entry) to host page table entries (hPT entry) during virtualization. The crossbar (XBAR) provides a parallel communication capability to enhance data transmission efficiency between a processor and a memory, while a DRAM, as a core of a main memory, requires periodic refreshing to maintain data validity.
4. gPT walker: It is configured to access and search for page tables within a virtual machine, and is frequently used in virtualized environments.
5. Host page table walker: It is a component that accesses internal page tables of a host operating system and manages mappings of a host virtual address space.
6. Page walk cache module: It is a caching mechanism configured to store recently used page table entries, to speed up a page table walking process.
7. SgCR3 register: It stores guest page table base addresses and is configured to point to page tables of a guest physical address space.
8. gCR3 Register: It records page table base addresses associated with a current virtual machine context and is used for address translation.
9. Page table lookup operation: It is a process of obtaining physical addresses corresponding to virtual addresses by searching a page table.
10. Cache line: It is a fundamental unit of data storage in a CPU cache, and typically includes a plurality of bytes. It defines a minimum granularity for acquiring data from a main memory.
11. DRAM: It is a semiconductor memory widely used in computers and electronic devices. It stores data dynamically and requires constant refreshing to retain information.
12. gPA: It is a physical memory address that can be directly accessed by virtual machines, and is translated through memory management of a host machine.
13. hPA: It is an actual physical memory address of a host machine, through which a physical address of a guest machine is mapped.
14. Shadow gPT entry: It is a page table entry maintained on a host machine, and is used to quickly translate GVAs to hPAs to avoid access to gPTs.
15. Translation lookaside buffer (TLB): It is a caching mechanism configured to store recently accessed virtual-to-physical address mappings, to speed up address translation.
16. gPT: It is a page table maintained within a virtual machine, and is used to manage mappings of virtual addresses to corresponding physical addresses in a guest operating system.
17. Nested TLB buffer: It is configured to enhance address translation efficiency in nested virtualized environments and store virtual machine address mappings.

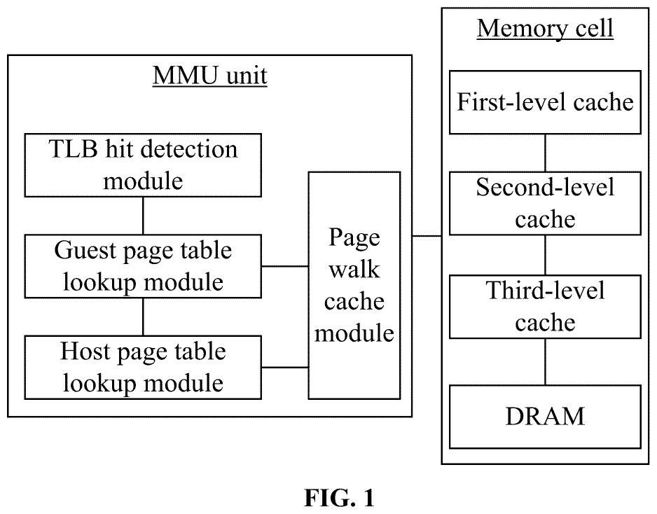

For ease of understanding the embodiments of this application, a detailed explanation is first provided with reference to FIG. 1. FIG. 1 is a schematic structural diagram of a hardware-assisted page table management system according to an embodiment of the present disclosure. The system includes an MMU and a memory cell. The MMU includes a TLB hit detection module, a guest page table lookup module, and a page walk cache module. The memory cell includes a first-level cache and a second-level cache. In the present disclosure, a gPA in a gPT in a cache is replaced with an hPA, to significantly reduce a need for nested address translation while maintaining software transparency for a guest operating system. A gPT entry including the hPA after the replacement is referred to as a shadow gPT entry.

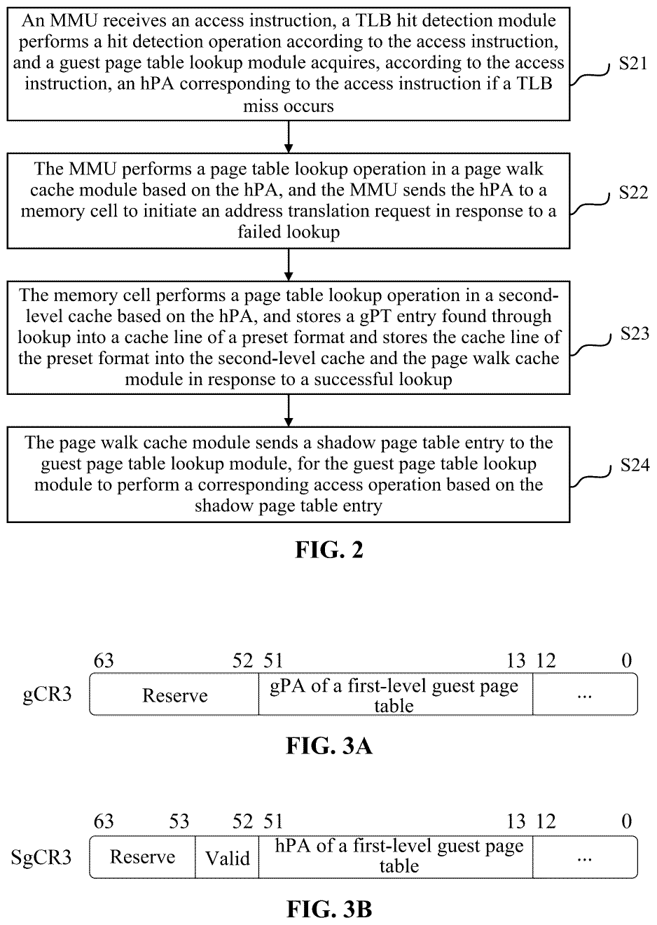

Interactions within the hardware-assisted page table management system described in this embodiment are shown in FIG. 2, mainly including following steps:

In step S21, the MMU receives an access instruction, the TLB hit detection module performs a hit detection operation according to the access instruction, and the guest page table lookup module acquires, according to the access instruction, an hPA corresponding to the access instruction if a TLB miss occurs.

In an embodiment of the present disclosure, after the hPA corresponding to the access instruction is acquired, a following step is further performed: storing the hPA into the guest page table lookup module and performing a valid bit setting operation on the guest page table lookup module.

In an embodiment of the present disclosure, a process in which the guest page table lookup module obtains, according to the access instruction, the hPA corresponding to the access instruction includes: requesting, by the guest page table lookup module, a host page table lookup module to translate a gPA into an hPA according to the access instruction. The host page table lookup module includes a host page table walker and a second register.

In an embodiment of the present disclosure, the guest page table lookup module includes a GPTW and a first register, and the first register includes a valid bit and a host physical address bit, where an initial state of the valid bit is an invalid state.

In an embodiment of the present disclosure, the first register is an SgCR3 register, and the second register is a gCR3 register. FIGS. 3A-3B are schematic structural diagrams of the SgCR3 register and the gCR3 register in this embodiment. In the gCR3 register, bits 65-52 are reserved bits, and bits 51 to 13 store gPAs of a first-level gPT. In the SgCR3 register, bits 65 to 53 are reserved bits, bits 53 to 52 are valid bits, and bits 51 to 13 store hPAs of the first-level gPT. The reserved bits in the register are unused register bits reserved for future expansion or compatibility purposes. 1 of the reserved bits in the SgCR3 register is set to a valid bit to indicate whether the hPAs currently stored in the SgCR3 are valid.

In this embodiment, the SgCR3 register is configured to directly provide first-level hPAs of the gPT to the GPTW, to reduce additional translation or lookup steps, thereby reducing a latency. The GPTW is a structure used in virtualized environments to search for and resolve gPTs. Conventional GPTWs are configured to map gVAs to gPAs. The mapping process includes function lookup functionality, hierarchical structure, and address translation. The GPTW accesses the gPTs level by level from a first-level page table until a target page table entry is found. A gPT typically adopts a multi-level structure, which, for example, may be a second-level or third-level page table, and acquires physical addresses by reading content of each layer. In this embodiment, when the guest operating system initiates a memory access request, the GPTW directly performs access by using the hPAs stored in the SgCR3 register.

In this embodiment, the operating system and a hypervisor are forbidden from directly modifying the SgCR3 register, to ensure system stability and security. The initial state of the valid bit is set to an invalid state to indicate that currently the SgCR3 register has not established a valid hPA mapping. The SgCR3 register and the gCR3 register maintain coherency through automatic access and synchronization mechanisms. Specifically, when the SgCR3 is in an invalid state, a gPA is automatically retrieved from the gCR3 register, the MMU is requested to translate the gPA to an hPA, the generated hPA is stored into the SgCR3, and a valid bit is set, to establish a mapping from the gPA to the hPA.

Further, when the gCR3 register is modified, the valid bit of the SgCR3 is cleared, to achieve address re-translation during next access, thereby ensuring that all updates are manifested and avoiding potential data incoherency. Maintaining coherency between the SgCR3 register and the gCR3 register is crucial for stability and data integrity of the system. If the two registers are not synchronous, memory access errors may occur, affecting overall performance of the system. Moreover, through the design of dynamic mapping and the intelligent invalidation mechanism, the SgCR3 effectively adapts to varying memory demands, improving access efficiency, and reducing an expected latency.

In an embodiment of the present disclosure, a process in which the guest page table lookup module acquires, according to the access instruction, the hPA corresponding to the access instruction includes: communicatively connecting the first register to the second register, and acquiring, by the first register a gPA from the second register according to the access instruction; searching, by the second register, a host page table walker for a corresponding hPA based on the gPA, and sending the hPA to the first register; and storing, by the MMU, the hPA into the first register, and setting the valid bit in the first register to a valid state.

In step S22, the MMU performs a page table lookup operation in the page walk cache module based on the hPA, and the MMU sends the hPA to the memory cell to initiate an address translation request in response to a failed lookup.

In an embodiment of the present disclosure, the MMU is configured to perform address translation and memory management. The MMU translates virtual addresses into physical addresses to help a processor access a memory. In this embodiment, the hPA is input into the MMU, and the MMU searches the page walk cache module for a corresponding page table entry. A page walk cache is a caching mechanism configured to store recently used page table information, to speed up page table lookup operations. A page table is used to map virtual addresses to physical addresses. By performing the page table lookup operation, the MMU can quickly determine a physical page corresponding to the hPA. However, if the MMU fails to find a matching page table entry in the cache, the MMU needs to perform a further address translation operation in a main memory cell. Subsequently, the MMU sends the hPA to the memory cell to initiate an address translation request, to request a memory management system or other hardware components, such as a main memory, to perform deeper address translation to determine an actual physical address.

In step S23, the memory cell performs a page table lookup operation in the second-level cache based on the hPA, and stores a gPT entry found through lookup into a cache line of a preset format and stores the cache line of the preset format into the second-level cache and the page walk cache module in response to a successful lookup.

In an embodiment of the present disclosure, the cache line of the preset format includes a flag, a status bit, a plurality of gPT entries, and a first shadow flag bit. Each gPT entry includes a second shadow flag bit and a page number. The first shadow flag bit includes a first flag and a second flag, the first flag is used to indicate that a current cache line includes a gPT entry replaced with the shadow page table entry, and the second flag is used to indicate that a current cache line does not include a gPT entry replaced with the shadow page table entry. The second shadow flag bit includes a third flag and a fourth flag, the third flag is used to indicate that a current gPT entry is replaced with the shadow page table entry, and the fourth flag is used to indicate that a current gPT entry is not replaced with the shadow page table entry.

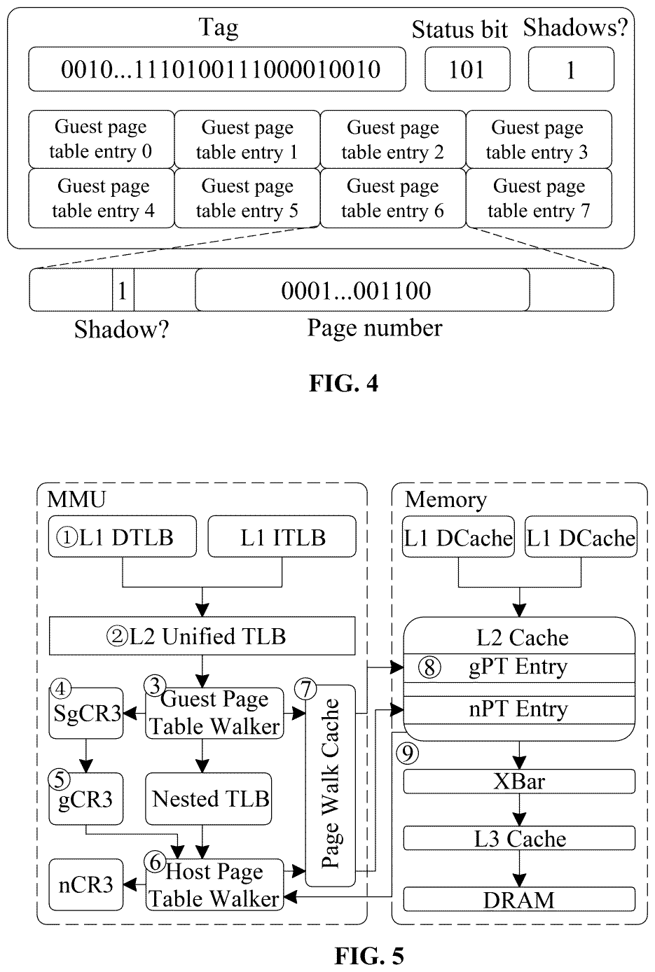

FIG. 4 is a schematic structural diagram of a cache line according to an embodiment of the present disclosure, including a 64-byte cache line with eight 8-byte gPT entries. The present disclosure creatively selects a bit from unused bits of each gPT entry as a shadow flag bit to indicate whether the gPT entry is a shadow gPT entry or an original gPT entry. Exemplarily, in the initial state, a value of the shadow flag bit is set to 0, indicating that the gPT entry is in an original state. When the cache translates the original gPT entry into a shadow gPT entry, the shadow flag bit is set to 1. In this case, the current cache line cannot be directly read by the guest operating system and cannot be written back to the memory, thereby ensuring memory security and validity of the virtual machine.

It is worth noting that this innovation effectively reduces storage demands by utilizing the unused bits of the gPT entries as shadow flag bits, thereby eliminating a need for additional storage overheads and improving memory utilization efficiency. Furthermore, the use of the shadow flag bits enables rapid identification of a state of the gPT entries, thereby optimizing the address translation process. This efficient state indication reduces a lookup time and enhances the overall performance of the system. In addition, when the original gPT entry is translated into a shadow gPT entry, a policy of being inaccessible to direct read or write back to a memory is adopted, which enhances the security of the virtual machine. This design prevents the guest operating system from directly accessing sensitive data, thereby ensuring memory protection.

In an embodiment of the present disclosure, efficient lifecycle management is provided for the foregoing shadow gPT entry. Although translating the original gPT entry into the shadow gPT entry can speed up page table walk, the original gPT entry still needs to be retained for management by the guest operating system. Moreover, to prevent modification or replacement of a unique copy in the cache system, a protection mechanism is established during creation of a shadow gPT entry. This ensures that the original gPT entry can be securely stored and remain valid during translation of page table entries.

Specifically, when a shadow flag bit of a data block in the L2 cache is updated from 0 to 1, it indicates that the data block includes only original gPT entries, with one of the entries ready to be translated into a shadow gPT entry. In this process, the L2 cache first writes the data block back to the L3 cache, to ensure that all original gPT entries are securely stored in the L3 cache This prevents losses of original gPAs in the gPT. When the L2 cache moves a data block including a shadow gPT entry to the L3 cache due to replacement, the system first determines whether a corresponding shadow data block exists in the L3 cache. If a corresponding shadow data block exists, the L3 cache writes the data block to the main memory, and the main memory stores the original gPT entries. When the L3 cache needs to evict the data block including shadow gPT entry, the data block is directly discarded. If the shadow gPT entry needs to be accessed again in the future, the system re-translates the shadow gPT entry from a corresponding original gPT entry. These mechanisms jointly ensure efficient management of page tables and data integrity. In simple terms, these mechanisms enable effective management of a virtual memory, ensuring that critical data is never lost and can be quickly accessed and updated.

In an embodiment of the present disclosure, a process in which the gPT entry found through lookup is stored into the cache line of the preset format into the second-level cache includes: performing, by the second-level cache, determination on the second shadow flag bit in the current gPT entry, translating the current gPT entry into a corresponding shadow page table entry through a nested page table addresser in the memory cell and setting the second shadow flag bit to a third flag if the second shadow flag bit is a fourth flag, storing the translated gPT entry into the current cache line, and setting the first shadow flag bit of the current cache line to the first flag.

FIG. 5 is a schematic flowchart of address translation according to an embodiment of the present disclosure. As shown in step 1 and step 2, when both an L1 TLB miss and an L2 TLB miss occur, a GPTW is activated to perform a page table walk operation in step 3. A process of the page table walk operation includes acquiring an hPA of a global level 4 page table (gL4) from an SgCR3 register in step 4. As described in a previous embodiment, an initial state of a valid bit in the SgCR3 register is an invalid state. During first access, the SgCR3 register acquires a gPA of the gL4 from a gCR3 register in step 5, and requests a host page table walker to translate the gPA into an hPA, stores the translated hPA into the SgCR3 register, and marks the valid bit in the SgCR3 register as valid in step 6.

Further, as shown in step 7, the GPTW searches a page walk cache (PWC) for a shadow gPT entry. If the shadow gPT entry is not found in the PWC, an L2 cache is accessed. In step 8, if a gPT entry is found in the L2 cache or a corresponding entry is retrieved from a lower-level cache, the L2 cache determines whether a shadow flag bit of the requested gPT entry is set to 1. If not, the L2 cache sends a request to a nested page table walker (NPTW) (step 9), to translate the gPT entry into a shadow gPT entry and sets the shadow flag bit to 1. Finally, the shadow gPT entry is buffered into the L2 cache and the PWC, and finally returned to the GPTW. This allows the guest page table walker to directly access a next-level guest page table by using the hPA of the shadow gPT entry, thereby avoiding a need to request the nested translation lookaside buffer (NTLB) or perform nested page table walk (PTW). The NTLB is a memory management mechanism intended to support virtualization technologies and optimize memory access by improving efficiency of address translation in virtualized environments. The NTLB is primarily used for memory access between a hypervisor and a VM, and enables multi-level mappings between virtual addresses of the VM and the hPAs.

In step S24, the page walk cache module sends a shadow page table entry to the guest page table lookup module, for the guest page table lookup module to perform a corresponding access operation based on the shadow page table entry.

In an embodiment of this application, the interaction mode of the system includes one or more of following steps: sending, if a first-level cache miss occurs concurrently with a second-level cache hit and a second shadow flag bit of a gPT entry that hits a request is a fourth flag, the gPT entry that hits the request to the first-level cache of the memory cell; requesting another layer of cache structure or a DRAM to provide a cache line without shadow page table entries if a first-level cache miss occurs concurrently with a second-level cache hit and the second shadow flag bit of the gPT entry that hits the request is a third flag, where the cache line without shadow page table entries is sent to the first-level cache of the memory cell; and performing, by the MMU and the memory cell, a gPT entry coherency maintenance operation if a first-level cache miss occurs concurrently with a second-level cache miss.

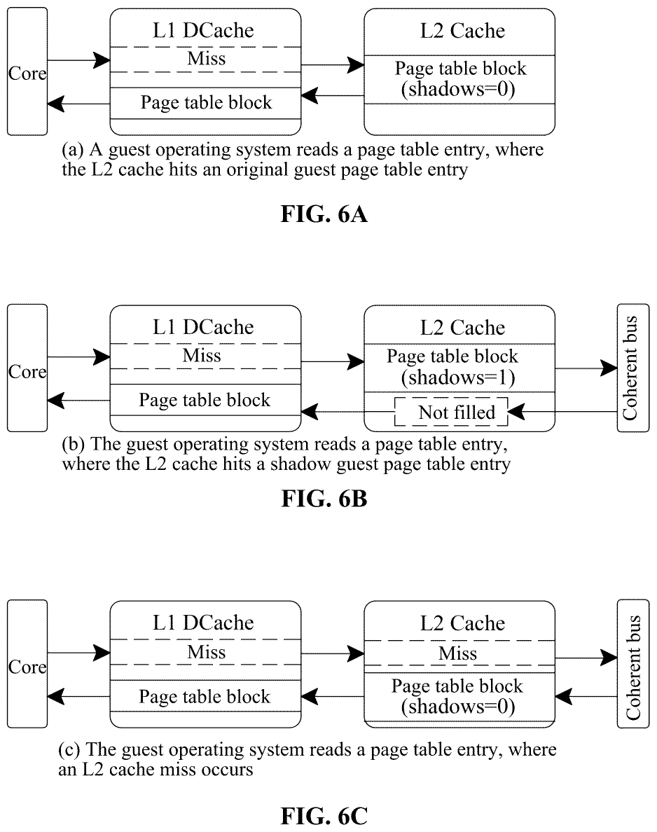

As shown in FIGS. 6A-6C, in this embodiment, when the guest operating system reads the gPA entry, if the requested gPT entry is not found in the L1 data cache, the request is further sent to the L2 cache. Corresponding operations are performed depending on a hit status of the L2 cache and shadow flag bit setting.

Specifically, this embodiment includes three scenarios. In scenario one, if the L2 cache hits the requested gPT entry and the shadow flag bit (Shadows) in the cache block is not set, that is, is the third flag in the foregoing text, it indicates that the requested gPT entry is found in the current L2 cache and that no gPT entry in the cache data block (cache line) is translated into a shadow gPT entry. In this case, since the shadow flag bit is not set, the gPT entry remains an original valid entry and can be directly used for physical address translation. The L2 cache directly forwards the currently hit cache data block to the L1 data cache to fulfill the access request from the guest operating system.

In scenario two, if the L2 cache hits the requested gPT entry and the shadow flag bit (Shadows) in the cache block is set, it indicates that a block including the requested gPT entry includes one or more shadow gPT entries. To prevent the guest operating system from reading the shadow gPT entries, the L2 cache cannot directly return the block to the L1 data cache. Directly returning the block may cause the guest operating system to acquire invalid or incoherent data, triggering security and stability problems. Therefore, the L2 cache needs to request a block with an unset shadow flag bit from another cache or from the DRAM through a bus. This ensures that the returned data is valid without shadow gPT entries. Once a requested valid block is successfully received, the L2 cache directly sends the data to the L1 data cache without updating the L2 cache, to avoid overwriting any existing shadow gPT entries.

For scenario three, if the requested gPT entry is not found in the L2 cache, the L2 cache follows a standard cache miss processing procedure and requests a target block. When the guest operating system writes a guest page table, the system initiates a coherency request to ensure that the L1 data cache retains an exclusive or modified copy of a target gPT entry block. This operation invalidates all copies of related blocks in the L2 and L3 caches. Moreover, the related gPT entries also need to be invalidated in the PWC module. To maintain PWC coherency, a PWC cleanup operation is performed during TLB flushes. This ensures that after a gPT is modified, stale shadow gPT entries in the PWC and the L2 and L3 caches are promptly invalidated, thereby eliminating a risk of data incoherency.

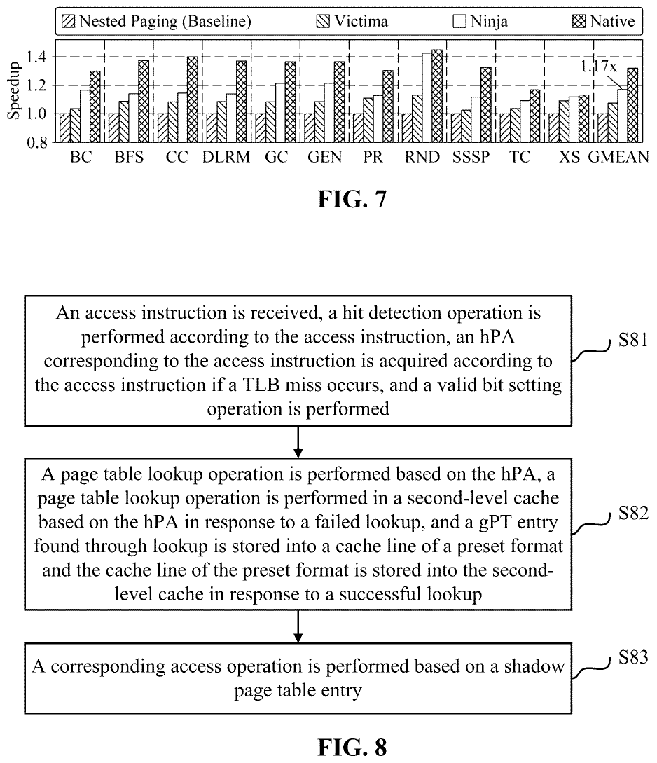

To evaluate performance and energy efficiency of the present disclosure, the present disclosure is subjected to a multi-load experiment and compared with existing methods. An experimental result shows that, in this experiment, the method corresponding to the present disclosure is named Ninja. In FIG. 7, a horizontal axis represents common computing tasks and algorithms, while a longitudinal axis represents a speedup ratio (Speedup). A higher value of the speedup ratio indicates more significant performance improvement. The horizontal axis represents various algorithms, such as betweenness centrality (BC), used to evaluate significance of node connections in a network; breadth-first search (BFS), a graph search algorithm that walks through adjacent nodes level by level from a starting node; connected component (CC), representing a largest subgraph in the graph that is reachable but not connected to other parts; deep learning recommendation model (DLRM), a deep learning algorithm used for personalized recommendation; graph coloring (GC), an algorithm used to color the nodes in the graph to ensure that adjacent nodes have different colors; genomic benchmark testing (k-mercounting in GenomicsBench), a benchmark workload used to evaluate performance of a computing systems; PageRank (PR), an algorithm that determines significance of a webpage based on a link structure; random access (RND), a process of randomly selecting a path in the graph for a walk; shortest path (SP), used to calculate a shortest path from a source node to other nodes; triangle counting (TC), used to analyze structural characteristics of the graph by calculating a number of triangles in the graph; and Monte Carlo macroscopic cross section lookup benchmark (XSBench, XS), where the Monte Carlo method is a numerical method based on random sampling, and is widely used in computational simulation and optimization issues of various fields, and macroscopic cross section lookup is a process of finding the optimal solution within a large-scale search space; and geometric mean (GMEAN), a statistical method used to assess comprehensive performance based on different test results.

FIG. 7 shows performance of Victima, the present disclosure, and Native (non-virtualized environment performance, as a reference) in terms of execution time speedup. The present disclosure demonstrates significantly superior performance than the existing technologies. On average, the present disclosure achieves a 17% increase over nested paging and an 8.5% increase over Victima. Moreover, with the optimization of the present disclosure, the average performance in the virtualized environment increases from original 76% to 89% of a native performance level.

In this embodiment of this application, the terms such as “first” and “second” are used to distinguish between same or similar items that have substantially the same function and effect. For example, the first shadow flag bit and the second shadow flag bit are merely used to distinguish between different shadow flag bits, rather than limit a sequential order. A person skilled in the art may understand that the terms such as “first” and “second” are not intended to limit a number and an execution sequence and are not necessarily intended to be different.

It should be noted that the word such as “exemplary” or “for example” in this embodiment of this application represents serving as an example, an instance, or an illustration. Any embodiment or design solution described herein as “exemplary” or “for example” should not be construed as being more preferred or advantageous over other embodiments or design solutions. Exactly, use of the word such as “exemplary” or “for example” is intended to present a related concept in a specific manner.

In this embodiment of this application, the term “at least one” means one or more, and the term “a plurality of” means two or more. The term “and/or” is used to describe an association relationship between associated objects, and represents that three relationships may exist. For example, A and/or B may represent that only A exists, both A and B exist, or only B exists, where A or B may be singular or plural. The character “/” usually indicates an “or” relationship between associated objects. “At least one of the following items” or a similar expression is any combination of these items, including a single item or any combination of a plurality of items. For example, at least one of a, b, or c may represent a, b, c, a and b, a and c, b and c, or a, b, and c, where a, b, and c may be singular or plural.

FIG. 8 is a schematic flowchart of a hardware-assisted page table management method according to an embodiment of this application. As shown in FIG. 8, the hardware-assisted page table management method includes following steps.

In step S81, an access instruction is received, a hit detection operation is performed according to the access instruction, an hPA corresponding to the access instruction is acquired according to the access instruction if a TLB miss occurs, and a valid bit setting operation is performed.

In step S82, a page table lookup operation is performed based on the hPA, a page table lookup operation is performed in a second-level cache based on the hPA in response to a failed lookup, and a gPT entry found through lookup is stored into a cache line of a preset format and the cache line of the preset format is stored into the second-level cache in response to a successful lookup.

In step S83, a corresponding access operation is performed based on a shadow page table entry.

It should be understood that the specific processes in which each module performs the foregoing corresponding steps have been described in detail in the foregoing method embodiments. For conciseness, details are not described herein.

It should be further understood that the division of modules in the embodiments of this application is schematic, which is only logical function division, and there may be another division method in actual implementation. In addition, the functional modules in the embodiments of this application may be integrated into one processor, or each may exist alone physically, or two or more modules may be integrated into one module. The integrated modules may be implemented in a form of hardware, or may be implemented in a form of a software functional module.

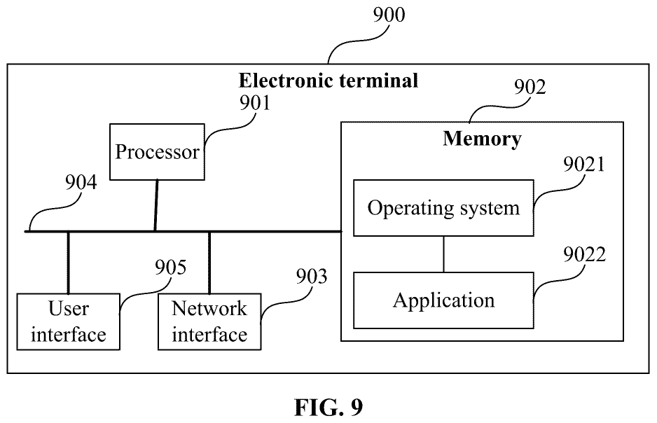

FIG. 9 is a schematic block diagram of an electronic terminal according to an embodiment of this application. As shown in FIG. 9, the electronic terminal includes at least one processor 901, a memory 902, at least one network interface 903, and a user interface 905. The components in the device are coupled together through a bus system 904. It may be understood that the bus system 904 is configured to implement connection and communication between these components. The bus system 904 includes not only a data bus, but also a power bus, a control bus, and a status signal bus. However, for clarity, various buses are labeled as a bus system in FIG. 9.

The user interface 905 may include a display, a keyboard, a mouse, a trackball, a key, a button, a touchpad, a touch screen, or the like.

It may be understood that the memory 902 may be a volatile memory or a non-volatile memory, or may include both a volatile memory and a non-volatile memory. The non-volatile memory may be read-only memory (ROM) or a programmable read-only memory (PROM), which is used as an external cache. By way of example but not limitation, many forms of random access memories (RAM), such as a static random access memory (SRAM) and a synchronous static random access memory (SSRAM) are available. The memory described in this embodiment of the present disclosure is intended to include, but is not limited to, these and any other suitable types of memories.

The memory 902 in this embodiment of the present disclosure is configured to store various types of data to support operations of the electronic terminal 900. Examples of these data include any executable program configured to be operated on the electronic terminal 900, such as an operating system 9021 and an application 9022. The operating system 9021 includes various system programs, such as a framework layer, a core library layer, and a driver layer, to implement various basic services and process hardware based tasks. The application 9022 may include various applications, such as a media player and a browser, to implement various application services. The hardware-assisted page table management method provided in the embodiments of the present disclosure may be included in the application 9022.

The methods disclosed in the foregoing embodiments of the present disclosure may be applied to the processor 901 or implemented by the processor 901. The processor 901 may be an integrated circuit chip with a signal processing capability. During implementation, each step of the foregoing methods may be completed through hardware integrated logic circuits or software instructions in the processor 901. The processor 901 may be a general-purpose processor, a digital signal processor (DSP), or another programmable logic device (PLD), discrete gate, or transistor logic device, a discrete hardware component, or the like. The processor 901 can implement or perform the methods, steps, and logic block diagrams disclosed in the embodiments of the present disclosure. The general-purpose processor 901 may be a microprocessor, any conventional processor, or the like. The steps of the hardware-assisted page table management method provided in the embodiments of the present disclosure may be directly implemented by a hardware decoding processor, or by a combination of hardware and software modules in the decoding processor. The software modules may be located in a storage medium. The storage medium is located in a memory. The processor reads information in the memory and complete the steps of the foregoing methods in combination with the hardware of the processor.

In an exemplary embodiment, the electronic terminal 900 may be implemented by one or more application specific integrated circuits (ASIC), DSPs, PLDs, and complex programmable logic devices (CPLD) to perform the foregoing methods.

According to the methods provided in the embodiments of the present disclosure, the present disclosure further provides a computer program product. The computer program product includes computer program code. The computer program code, when run on a computer, causes the computer to perform the hardware-assisted page table management method according to any one of the foregoing embodiments.

According to the methods provided in the embodiments of the present disclosure, the present disclosure further provides a computer-readable storage medium. The computer-readable storage medium has program code stored therein. The program code, when run on a computer, causes the computer to perform the hardware-assisted page table management method according to any one of the foregoing embodiments.

The terms such as “component”, “module”, and “system” used in this specification are used to represent a computer-related entity, hardware, firmware, a combination of hardware and software, software, or software in execution. For example, the component may be, but is not limited to, a process run on a processor, a processor, an object, an executable file, a thread of execution, a program, and/or a computer. As illustrated, both an application run on the computer device and the computer device may be components. One or more components may reside in a process and/or a thread of execution, and the components may be located on one computer and/or distributed between two or more computers. In addition, these components may execute operations from various computer-readable media in which various data structures are stored. The components may communicate through local and/or remote processes based on, for example, signals having one or more data packets (for example, data from two components interacting with another component between a local system, a distributed system, and/or a network; for another example, the Internet interacting with other systems via signals).

A person of ordinary skill in the art may be aware that the various illustrative logical blocks and steps described in the embodiments disclosed herein may be implemented through electronic hardware, or through a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

A person skilled in the art may clearly understand that, for ease and brevity of description, reference may be made to corresponding processes in the foregoing method embodiments for specific operating processes of the foregoing systems, apparatuses, and units. Details are not described herein.

In the plurality of embodiments provided in this application, it should be understood that the disclosed systems, apparatuses, and methods may be implemented in other manners. For example, the apparatus embodiments described above are merely examples. For example, the unit division is merely logical function division and may be other division during actual implementation. For example, a plurality of units or components may be combined or integrated into another system, or some features may be ignored or not performed. In addition, the displayed or discussed mutual couplings or direct couplings or communicative connections may be implemented through some interfaces. The indirect couplings or communicative connections between the apparatuses or units may be implemented in electrical, mechanical, or other forms.

The units described as separate components may or may not be physically separate. Components shown as units may or may not be physical units, which may be located in one position, or may be distributed on a plurality of network units. Some or all of the units may be selected according to actual needs to achieve the objectives of the solutions of the embodiments.

In addition, functional units in the embodiments of this application may be integrated into one processing unit, or each may exist alone physically, or two or more units may be integrated into one unit.

The functions of each functional unit in the foregoing embodiments may be implemented in whole or in part through software, hardware, firmware, or any combination of software, hardware, and firmware. When software is used for implementation, the implementation may be performed in whole or in part in a form of a computer program product. The computer program product includes one or more computer instructions (programs). When the computer program instructions (programs) are loaded and executed on a computer, some or all of the processes or functions according to the embodiments of this application are implemented. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, and microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a high-density digital video disc (DVD)), a semiconductor medium (for example, a solid state disk (SSD)), or the like.

If implemented in a form of a software functional unit and sold or used as a standalone product, functions may be stored in a computer-readable storage medium. Based on such an understanding, the technical solutions in this application essentially, or the part contributing to the prior art, or some of the technical solutions may be implemented in a form of a software product. The computer software product is stored in a storage medium, and includes instructions for instructing a computer device (which may be a personal computer, a server, a network device, or the like) to perform all or some of the steps of the methods described in the embodiments of this application. The foregoing storage medium includes any medium that can store program code, such as a USB flash disk, a mobile hard disk, a ROM, a RAM, a magnetic disk, or an optical disk.

The foregoing descriptions are merely specific implementations of the present disclosure, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

In conclusion, this application provides a hardware-assisted page table management system and method, a medium, a program product, and a terminal, providing a page table caching management method in a virtualization system. This method achieves efficient address translation through collaborative operation of a MMU and a memory cell. The method includes key steps such as TLB hit detection, guest page table lookup, and page walk cache lookup. After receiving an access instruction, the MMU performs detection through a TLB hit detection module. If a miss occurs, a guest page table lookup module acquires a corresponding hPA. The system performs lookup in a page walk cache module, accesses a second-level cache of the memory cell when necessary, and stores a lookup result into a cache line of a preset format. The present disclosure achieves transparent translation of guest page table addresses in a cache through hardware-assisted means, providing a comprehensive lifecycle management solution for shadow page table entries. Therefore, this application effectively overcomes various shortcomings of the prior art and possesses high industrial utility value.

The foregoing embodiments are merely illustrative of the principles and effects of this application and are not intended to limit this application. Any person skilled in the art may make modifications or alterations to the foregoing embodiments without departing from the spirit and scope of this application. Thus, all equivalent modifications or alterations made by those of ordinary skill in the art without departing from the spirit and technical teachings disclosed in this application shall fall within the scope defined by the claims of this application.

1. A hardware-assisted page table management system, comprising: a memory management unit (MMU) and a memory cell, wherein
the MMU comprises a translation lookaside buffer (TLB) hit detection module, a guest page table lookup module, and a page walk cache module;
the memory cell comprises a first-level cache and a second-level cache; and
an interaction mode of the hardware-assisted page table management system comprises following steps:
receiving, by the MMU, an access instruction, performing, by the TLB hit detection module, a hit detection operation according to the access instruction, and acquiring, by the guest page table lookup module according to the access instruction, a host physical address corresponding to the access instruction when a TLB miss occurs;
performing, by the MMU, a page table lookup operation in the page walk cache module based on the host physical address, and sending, by the MMU, the host physical address to the memory cell to initiate an address translation request in response to a failed lookup;
performing, by the memory cell, a page table lookup operation in the second-level cache based on the host physical address, and in response to a successful lookup, storing a found guest page table entry into a cache line of a preset format and storing the cache line of the preset format into the second-level cache and the page walk cache module; and
sending, by the page walk cache module, a shadow page table entry to the guest page table lookup module, for the guest page table lookup module to perform a corresponding access operation based on the shadow page table entry.

2. The hardware-assisted page table management system according to claim 1, wherein the cache line of the preset format comprises a flag, a status bit, a plurality of guest page table entries, and a first shadow flag bit, and each of the plurality of guest page table entries comprises a second shadow flag bit and a page number;
the first shadow flag bit comprises a first flag and a second flag, the first flag is used to indicate that a current cache line comprises a guest page table entry replaced with the shadow page table entry, and the second flag is used to indicate that a current cache line does not comprise a guest page table entry replaced with the shadow page table entry; and
the second shadow flag bit comprises a third flag and a fourth flag, the third flag is used to indicate that a current guest page table entry is replaced with the shadow page table entry, and the fourth flag is used to indicate that a current guest page table entry is not replaced with the shadow page table entry.

3. The hardware-assisted page table management system according to claim 2, wherein the storing a found guest page table entry into a cache line of a preset format comprises:
performing, by the second-level cache, determination on the second shadow flag bit in the current guest page table entry, translating the current guest page table entry into a corresponding shadow page table entry through a nested page table addresser in the memory cell and setting the second shadow flag bit to a third flag when the second shadow flag bit is a fourth flag, storing the translated guest page table entry into the current cache line, and setting the first shadow flag bit of the current cache line to the first flag.

4. The hardware-assisted page table management system according to claim 2, wherein the interaction mode of the system comprises one or more of following steps:
sending, when a first-level cache miss occurs concurrently with a second-level cache hit and a second shadow flag bit of a guest page table entry that hits a request is a fourth flag, the guest page table entry that hits the request to the first-level cache of the memory cell;
requesting another layer of cache structure or a dynamic random access memory (DRAM) to provide a cache line without shadow page table entries when a first-level cache miss occurs concurrently with a second-level cache hit and the second shadow flag bit of the guest page table entry that hits the request is a third flag, wherein the cache line without shadow page table entries is sent to the first-level cache of the memory cell; and
performing, by the MMU and the memory cell, a guest page table entry coherency maintenance operation when a first-level cache miss occurs concurrently with a second-level cache miss.

5. The hardware-assisted page table management system according to claim 1, wherein the guest page table lookup module comprises a guest page table walker and a first register, and the first register comprises a valid bit and a host physical address bit, wherein an initial state of the valid bit is an invalid state.

6. The hardware-assisted page table management system according to claim 5, wherein a process of acquiring, by the guest page table lookup module according to the access instruction, the host physical address corresponding to the access instruction comprises:
communicatively connecting the first register to a second register, and acquiring, by the first register a guest physical address from the second register according to the access instruction;
searching, by the second register, a host page table walker for a corresponding host physical address based on the guest physical address, and sending the host physical address to the first register; and
storing, by the MMU, the host physical address into the first register, and setting the valid bit in the first register to a valid state.

7. A hardware-assisted page table management method, applied to a computer processor and comprising:
receiving an access instruction, performing a hit detection operation according to the access instruction, acquiring, according to the access instruction, a host physical address corresponding to the access instruction when a TLB miss occurs, and performing a valid bit setting operation;
performing a page table lookup operation based on the host physical address, performing a page table lookup operation in a second-level cache based on the host physical address in response to a failed lookup, and storing a found guest page table entry into a cache line of a preset format and storing the cache line of the preset format into the second-level cache in response to a successful lookup; and
performing a corresponding access operation based on a shadow page table entry.

8. A non-transitory computer-readable storage medium, having a computer program stored therein, wherein the computer program, when executed by a processor, implements the hardware-assisted page table management method according to claim 7.

9. (canceled)

10. An electronic terminal, comprising a memory, a processor, and a computer program stored in the memory, wherein the processor is configured to execute the computer program to implement the hardware-assisted page table management method according to claim 7.
